(19) United States
(12) Patent Application Publication
(10) Pub. No.: US 2014/0152843 A1
(43) Pub. Date: Jun. 5, 2014

(54) OVERHEAD CAMERA AND METHOD FOR CONTROLLING OVERHEAD CAMERA

(71) Applicant: SEIKO EPSON CORPORATION, Tokyo (JP)

(72) Inventors: Shinji SAKURAI, Matsumoto-shi (JP); Yasunaga MIYAZAWA, Okaya-shi (JP)

(73) Assignee: SEIKO EPSON CORPORATION, Tokyo (JP)

(21) Appl. No.: 14/086,382

(22) Filed: Nov. 21, 2013

(30) Foreign Application Priority Data
Dec. 4, 2012 (JP) 2012-264855

(51) Int. Cl. H04N 5/232

(52) U.S. Cl. CPC H04N 5/232
USPC 348/169

(57) ABSTRACT

An overhead camera includes an imaging section that captures an image of a subject, a position recognition section that recognizes a position specified with an operation member operated toward the subject, and a projection section that projects a predetermined image in the position specified with the operation member.

### BACKGROUND

1. Technical Field

The present invention relates to an overhead camera and a method for controlling the overhead camera.

2. Related Art

As a technology of the type described above, there is a known visual system solution of related art formed of an overhead camera, a tablet terminal, and a monitor. For example, an interactive overhead camera (stereoscopic projector) L-12 (manufactured by Elmo Solution Company, http://www.elmosolution.co.jp/products/visual/l_{—}12/index.html) having the following configuration is disclosed: A captured image from the overhead camera and a drawn image based on drawing operation performed on the tablet terminal are combined with each other; and the combined image is displayed on the monitor. The configuration described above allows pseudo writing on a captured image displayed on the monitor.

The interactive overhead camera L-12, in which a user needs to perform drawing operation on the tablet terminal at hand while viewing the monitor, however, undesirably has a difficulty performing drawing operation in a desired position in the captured image displayed on the monitor. To solve the problem, JP-A-2012-138666 has been proposed. The JP-A-2012-138666 relates to a document presentation system formed of an overhead camera and a tablet terminal with a display function and operates as follows: A captured image from the overhead camera is wirelessly transmitted to the tablet terminal and displayed on an operation/display screen of the tablet terminal. The user performs drawing operation on the operation/display screen of the tablet terminal, and the tablet terminal reflects the drawn object in the image displayed on the operation/display screen. The configuration described above allows the user to perform drawing operation on the captured image displayed on the tablet terminal, providing an advantageous effect of satisfactory operability as compared with the operability provided by the configuration of the interactive overhead camera L-12, in which the user needs to perform drawing operation while viewing a captured image displayed on the monitor.

However, the configuration described in JP-A-2012-138666, in which drawing operation is performed indirectly on a captured image displayed on the tablet terminal, is also problematic in that the drawing operation is less intuitive than in a case where drawing operation is performed directly on a subject. In particular, when the subject is a three-dimensional object, there is conceivably a difficulty performing drawing operation in a desired position depending on the shape of the subject and the direction in which an image of the subject is captured.

### SUMMARY

An advantage of some aspects of the invention is to provide an overhead camera that allows a user who attempts to perform pseudo writing on a captured image to perform intuitive drawing operation on a subject and a method for controlling the overhead camera.

An overhead camera according to an aspect of the invention includes an imaging section that captures an image of a subject, a position recognition section that recognizes a position specified with an operation member operated toward the subject, and a projection section that projects a predetermined image in the position specified with the operation member.

A method for controlling an overhead camera according to another aspect of the invention includes: capturing an image of a subject, recognizing a position specified with an operation member operated toward the subject, and projecting a predetermined image in the position specified with the operation member.

According to the configurations of the aspects of the invention, since a predetermined image is projected in a position specified with the operation member operated toward the subject, the user can have a sensation as if the user performed drawing operation directly on the subject. Further, even when the subject is a three-dimensional object, since a desired position is specified with the operation member that is oriented toward the three-dimensional subject itself, the desired position can be more readily specified than in a configuration of related art in which a drawing position is specified on a two-dimensional captured image of the subject.

The “predetermined image” may be an arrow or any other pointer or may be a point.

In the overhead camera described above, when the position specified with the operation member is moved, the projection section may project a drawing path that visualizes the path along which the specified position has been moved.

In the configuration of the overhead camera according to the aspect of the invention described above, when the position specified with the operation member operated toward the subject is moved, a drawing path that visualizes the path along which the operation member has been moved is projected, whereby the user can have a sensation as if the user performed writing operation directly on the subject.

The configuration can be implemented by continuously recognizing the position specified with the operation member at short time intervals and continuously projecting a “point” (predetermined image) as the specified position is moved.

The overhead camera described above may further include a drawing judgment section that judges whether or not drawing operation is performed by using the operation member and an output section that outputs an image to an image display apparatus, and the output section may output realtime captured images being captured by the imaging section when no drawing operation is being performed by using the operation member, and output a combined image that is a combination of a captured image of the subject and the drawing path when drawing operation is being performed by using the operation member.

In the configuration of the overhead camera according to the aspect of the invention described above, an appropriate image can be outputted to the image display apparatus based on whether or not drawing operation is being performed by using the operation member. That is, in a period during which drawing operation is being performed, the operation member and a user's “hand” that grasps the operation member can be eliminated from an output image by outputting a combined image that is a combination of a captured image of the subject and the drawing path, whereby the output image can contain only information considered essentially required.

In the overhead camera described above, the drawing judgment section may judge whether or not drawing operation is being performed by using the operation member based on the state of the operation member.

In the overhead camera described above, the position recognition section may recognize the position of a light emitting member incorporated in the operation member as the position specified with the operation member, and the drawing judgment section may judge that the drawing operation is being performed when the position recognition section detects that the light emitting member is emitting light, whereas judging that the drawing operation is not being performed when the position recognition section detects that the light emitting member is not emitting light.

In the configuration of the overhead camera according to the aspect of the invention described above, whether or not drawing operation is being performed can be readily judged based on the state of the operation member (whether or not the light emitting member is emitting light, for example).

The light emitting member can, for example, be an infrared light source, an LED (light emitting diode), or a laser light source.

The overhead camera described above may further include a storage section that stores a most recently captured image and a few of the following captured images produced by the imaging section that regularly captures images, and the output section may read a predetermined captured image from the storage section when drawing operation is initiated by using the operation member and output a combined image that is a combination of the predetermined captured image and the drawing path in a period during which the drawing operation is being performed by using the operation member.

In the configuration of the overhead camera according to the aspect of the invention described above, since a captured image captured before the drawing operation starts and containing no operation member, a user's “hand” or the drawing path is read from the storage section, a captured image of the subject (image containing only subject) can be readily produced.

The “predetermined captured image” read from the storage section may be an image captured immediately before the drawing operation starts (most recently captured image), or when a plurality of captured images are stored in the storage section, the “predetermined captured image” may be a predetermined one of the captured images.

The overhead camera described above may further include a drawing judgment section that judges whether or not drawing operation is being performed by using the operation member and an output section that outputs an image to an image display apparatus, and when drawing operation is being performed by using the operation member, the output section may not output realtime captured images being captured by the imaging section but may output a subtracted image that does not contain the drawing path in a period during which the drawing operation is being performed by using the operation member.

The configuration of the overhead camera according to the aspect of the invention can be used in an application in which the user desires to check the drawing path on the subject but does not desire to include the drawing path in an output image (application in which the user does not desire the image display apparatus to display the drawing path). For example, in an educational scene, the configuration can be used by a teacher, for example, as follows: After the teacher asks students a question, the teacher writes an answer on the subject without showing it to the students; the teacher waits for a response from the students; and the teacher shows the answer (drawing path) on the image display apparatus.

The overhead camera described above may further include a storage section that stores a most recently captured image and a few of the following captured images produced by the imaging section that regularly captures images, and the subtracted image may be a predetermined captured image read from the storage section when drawing operation is initiated by using the operation member.

In the configuration of the overhead camera according to the aspect of the invention described above, the subtracted image can be readily produced by reading a captured image captured before the drawing operation starts. Further, an image that does not contain the operation member, the user's “hand,” or the drawing path but contains only the subject can be readily produced as the subtracted image.

In the overhead camera described above, the subtracted image may be an image produced by subtracting the drawing path from realtime captured images being captured by the imaging section.

In the configuration of the overhead camera according to the aspect of the invention described above, the subtracted image can be produced by subtracting the drawing path from realtime captured images being captured by the imaging section without operation of storing captured images captured before the drawing operation starts.

The overhead camera described above may further include a selection portion that allows selection of one of the realtime captured images being captured by the imaging section, the subtracted image, and the drawing path as an output from the output section, and the output section may output an image selected by using the selection portion in a period during which drawing operation is being performed by using the operation member.

In the configuration of the overhead camera according to the aspect of the invention described above, since the user can select a desired output image from the “realtime captured images,” the “subtracted image,” and the “drawing path,” the operability can be improved.

In the overhead camera described above, the projection section can project image data stored in advance or externally inputted image data toward the subject.

In the configuration of the overhead camera according to the aspect of the invention described above, not only an image produced by drawing operation (such as predetermined image and drawing path) but also arbitrary image data can be projected. For example, the configuration can be used in an educational scene where image data on a model of a written character is projected and a character is drawn on the model character by using the operation member.

In the overhead camera described above, the position recognition section may recognize the position specified with the operation member based on a result of imaging operation performed by the imaging section.

In the configuration of the overhead camera according to the aspect of the invention described above, since an image of the subject can be captured and the position of the operation member can be recognized with a single imaging sensor, calibration between the captured image and the recognized position can be omitted. Further, the configuration of the overhead camera can be simplified for cost reduction.

### BRIEF DESCRIPTION OF THE DRAWINGS

The invention will be described with reference to the accompanying drawings, wherein like numbers reference like elements.

FIG. 1 is a system configuration diagram of a projection system according to an embodiment of the invention.

FIG. 2 is a block diagram of an overhead camera according to a first embodiment.

FIGS. 3A and 3B show examples of a subject, a drawing path, a projection area, and an imaging area.

FIG. 4A shows an example of realtime captured images, and FIG. 4B shows an example of a combined image.

FIG. 5 is a flowchart showing the action of the overhead camera according to the first embodiment.

FIG. 6 is a block diagram of an overhead camera according to a second embodiment.

FIG. 7A shows an example of realtime captured images, FIG. 7B shows an example of a subtracted image, and FIG. 7C shows an example of a drawing path.

FIG. 8 is a flowchart showing the action of the overhead camera according to the second embodiment.

### DESCRIPTION OF EXEMPLARY EMBODIMENTS

An overhead camera and a method for controlling the overhead camera according to an embodiment of the invention will be described below in detail with reference to the accompanying drawings. In each embodiment, a case where a projector is used as an image display apparatus will be presented by way of example.

### First Embodiment

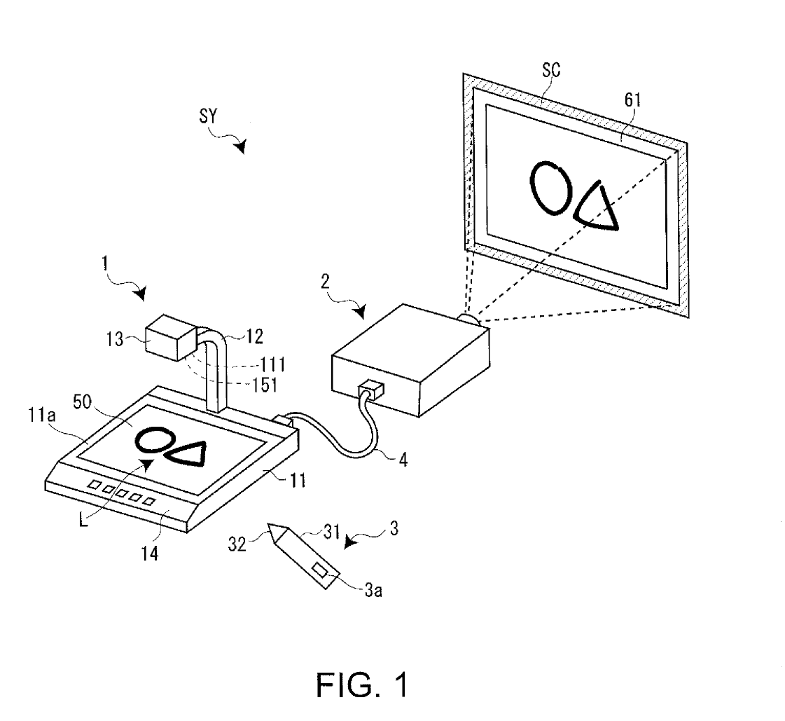

FIG. 1 is a system configuration diagram of a projection system SY according to an embodiment of the invention. The projection system SY is formed of an overhead camera 1 and a projector 2, which are connected to each other via a cable 4.

The overhead camera 1 includes a box-shaped enclosure 11, a support arm 12, which extends upward from an end portion of the enclosure 11, and a camera head 13, which is fixed to the upper end of the support arm 12. A stage 11a, which has a rectangular shape when viewed from above (from the side where the camera head 13 is present), and an operation panel 14, on which a plurality of operation keys are arranged, are provided on the upper surface of the enclosure 11. A subject 50, which is a planar object or a three-dimensional object, is placed on the stage 11a (FIG. 1 shows a case where a subject 50 that is a planar object is placed).

A light emitting pen 3 (operation member) is provided as an attachment to the overhead camera 1. The light emitting pen 3 has a nib 32 or a front tip to which an LED (light emitting member) is attached. When a user causes the nib 32 to come into contact with the subject 50, the LED emits light. Further, a switch 3a is provided on a main body 31 of the light emitting pen 3. Whenever the switch 3a is pressed down, the LED can alternately be turned on and off. Alternatively, the LED may keep emitting light when the user keeps pressing the switch 3a, and the LED may stop emitting light when the user stops pressing the switch 3a.

On the other hand, the camera head 13 is provided with an imaging sensor 111 and a projection lens 151, which face downward (toward the stage 11a). The imaging sensor 111 captures an image of the subject 50 placed on the stage 11a and the light emitting pen 3. The projection lens 151 projects a drawing path L (predetermined image), which visualizes the path along which the light emitting pen 3 (LED provided at nib 32) is moved, toward the subject 50. The imaging sensor 111 and the projection lens 151 are preferably so disposed that they are as close to each other as possible.

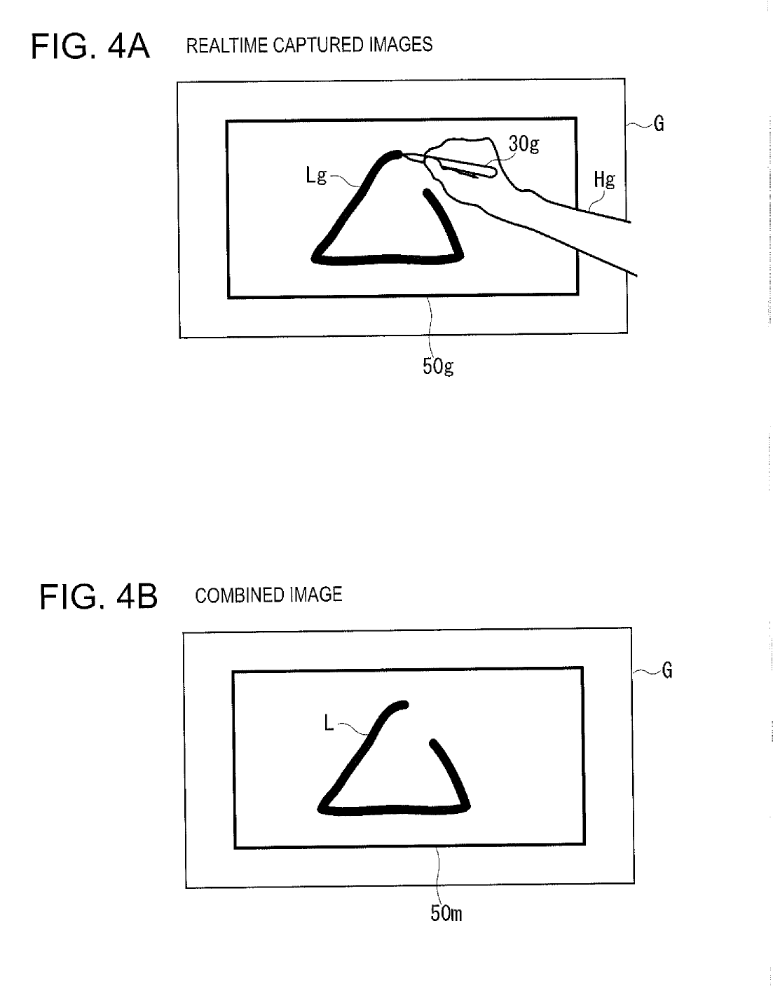

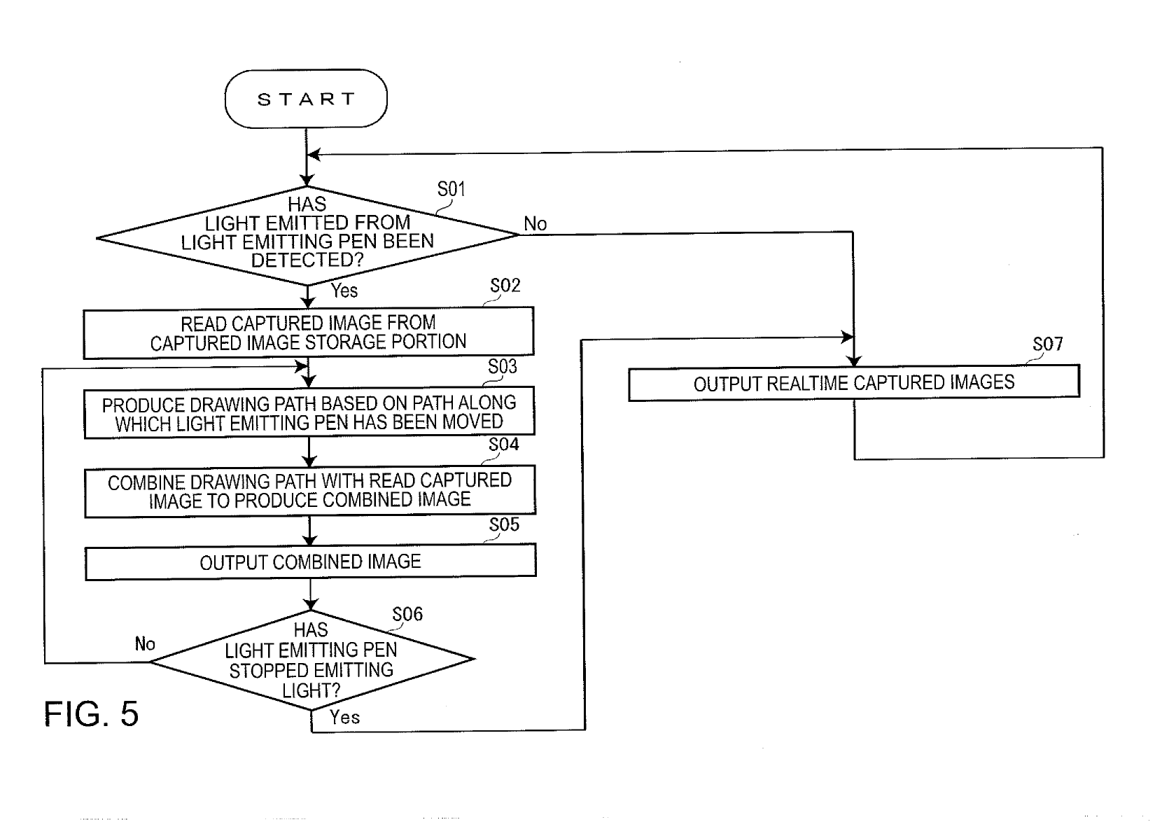

In the configuration described above, the overhead camera 1 processes images captured with the imaging sensor 111 to acquire a captured image 50m (see FIG. 4B) of the subject 50 and produce the drawing path L. A combined image that is a combination of the captured image 50m and the drawing path L or realtime captured images from the imaging sensor 111 are outputted as an output image G (see FIG. 5 and other figures) to the projector 2. The projector 2 acquires the output image G from the overhead camera 1 and projects a projection image for a projector 61 on a screen SC.

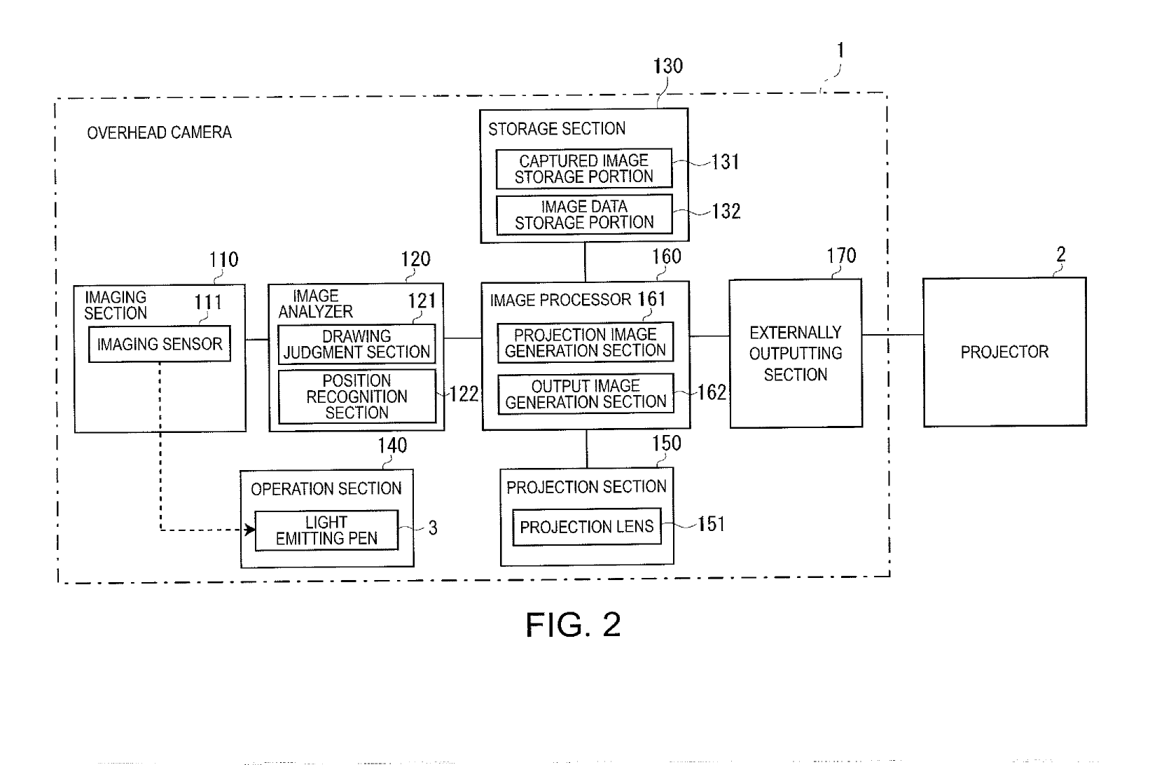

A functional configuration of the overhead camera 1 will next be described with reference to FIG. 2. The overhead camera 1 includes an imaging section 110, an image analyzer 120, a storage section 130, an operation section 140, a projection section 150, an image processor 160, and an externally outputting section 170, which form a primary functional configuration. The “output section” in the appended claims corresponds to the image processor 160 and the externally outputting section 170. The “storage section” in the appended claims corresponds to a captured image storage portion 131 in the storage section 130.

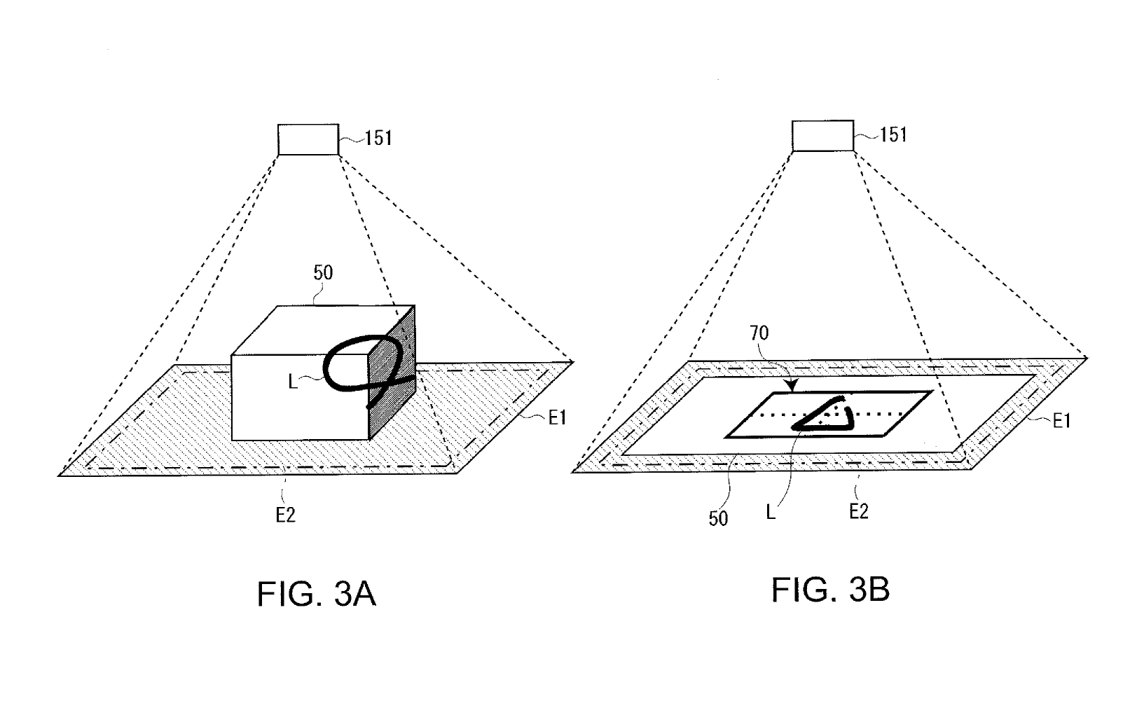

The imaging section 110 includes the imaging sensor 111 and an imaging lens (not shown) that focuses light reflected off the subject 50 or any other object onto a light receiving surface of the imaging sensor 111 and captures an image of an imaging area E2 (see FIGS. 3A and 3B) of the stage 11a. The imaging sensor 111 is used not only to capture an image of the subject 50 but also to recognize the position specified with the light emitting pen 3. A plurality of light receiving pixels arranged in a matrix are formed in the light receiving surface of the imaging sensor 111, which produces image data at a predetermined frame rate based on the amount of light received by the pixels. The imaging sensor 111 is formed of a CMOS (complementary metal oxide semiconductor) sensor or a CCD (charge coupled device) sensor.

When the user is performing drawing operation, an image captured by the imaging section 110 includes not only the subject 50 and the drawing path L projected by the projection section 150 but also the light emitting pen 3 used in the drawing operation, a user's “hand” that grasps the light emitting pen 3, and other objects. It is, however, conceivable that the user does not desire to have information, such as the light emitting pen 3 and the “hand,” contained in the projection image for a projector 61. To this end, in the present embodiment, the output image G is switched in accordance with the situation between the “realtime captured images” captured by the imaging section 110 and the “combined image” that does not contain the light emitting pen 3, the “hand,” or other types of information. The switching operation will be described later in detail.

The image analyzer 120 performs image analysis on a captured image that is a result of imaging operation performed by the imaging section 110 and includes a drawing judgment section 121 and a position recognition section 122. The drawing judgment section 121 judges whether or not the user is performing drawing operation by using the light emitting pen 3. Specifically, the drawing judgment section 121 judges that the user is performing drawing operation when the light emitted from the LED at the nib 32 is detected with the imaging sensor 111, whereas the drawing judgment section 121 judges that the user is not performing drawing operation when no light emitted from the LED at the nib 32 is detected with the imaging sensor 111. The position recognition section 122 recognizes the position of the nib 32 (position where LED emits light). The position recognition section 122 preferably recognizes the position at short time intervals, for example, at an interval of 1/60 to 1/24 seconds, so that the drawing path L can be drawn in realtime (without causing the user to feel uncomfortable) in response to the movement of the light emitting pen 3.

The storage section 130 is formed of a rewritable storage medium, such as a flash ROM, and includes a captured image storage portion 131 and an image data storage portion 132. The captured image storage portion 131 stores the most recently captured image of the images regularly captured by the imaging section 110. The stored captured image is read at a point when the drawing judgment section 121 judges that drawing operation has been started and used to produce a combined image. The captured image storage portion 131 may not store only the most recently captured image but may store the most recently captured image and a few of the following ones, and a predetermined one of them (second newest of three captured images stored in storage portion, for example) may be used to produce a combined image.

On the other hand, the image data storage portion 132 stores image data 70 (see FIG. 33) to be projected toward the subject 50. For example, when the projection system SY according to the present embodiment is used in an educational scene, it is conceivable to project a character entry box, a model of a written character, plotting paper, and other figures as the image data 70. The overhead camera 1 does not necessarily include the image data storage portion 132, but an Internet server capable of communicating with the overhead camera 1, the projector 2, or an external storage medium that can be read by the overhead camera 1 may input the image data 70.

The operation section 140 is used by the user to perform a variety of types of operation and includes the light emitting pen 3. In the present embodiment, when the user moves the light emitting pen 3 toward the subject 50, the imaging sensor 111 captures images of the moving light emitting pen 3, and the position recognition section 122 recognizes the movement path based on the captured images. The projection section 150 then projects the drawing path L, which visualizes the movement path.

The image processor 160 performs image processing based on the analysis results from the image analyzer 120 and includes a projection image generation section 161 and an output image generation section 162. The projection image generation section 161 generates a projection image to be projected by the projection section 150. The projection image contains the drawing path L and the image data 70.

The output image generation section 162 generates the output image G to be outputted to the projector 2 in accordance with the result of the judgment made by the drawing judgment section 121. Specifically, when the drawing judgment section 121 judges that the user is performing no drawing operation, the output image generation section 162 generates realtime captured images being captured by the imaging section 110 as the output image G. FIG. 4A shows a case where realtime captured images are displayed as the output image G. When the user is performing no drawing operation, realtime images being captured by the imaging section 110 (motion images containing image 50g of subject 50, image Lg of drawing path L, image 3g of light emitting pen 3, and image Hg of user's “hand”) are outputted as the output image G, as shown in FIG. 4A.

When the drawing judgment section 121 judges that the user is performing drawing operation, the output image generation section 162 generates a combined image that is a combination of the captured image 50m of the subject 50 captured by the imaging section 110 and the drawing path L obtained from the recognition result from the position recognition section 122. The “captured image 50m of the subject 50” refers to a captured image read from the captured image storage portion 131 when the drawing judgment section 121 judges that the user starts drawing operation. That is, it is assumed that a captured image before the drawing operation starts does not contain the light emitting pen 3, the “hand,” or any other type of information, and the “captured image read from the captured image storage portion 131” is used as a “captured image containing only the subject 50.” FIG. 4B shows a case where a combined image is displayed as the output image G. As shown in FIG. 4B, when the user is performing drawing operation, a combined image that is a combination of the captured image 50m of the subject 50 (still image) read from the captured image storage portion 131 and the drawing path L (motion images) is outputted as the output image G.

The projection section 150 projects a projection image generated by the projection image generation section 161 (drawing path L and/or image data 70) toward the subject 50 and includes the projection lens 151. Although not particularly shown, the projection section 150 further includes a light source device, such as a metal halide lamp, an LED, or a laser light source, and a light modulator, such as a liquid crystal panel. FIGS. 3A and 3B show a projection area E1, over which the projection section 150 performs projection, and the drawing path L. The projection section 150 (projection lens 151) performs projection over the projection area E1 including the imaging area E2 imaged by the imaging section 110, as shown in FIGS. 3A and 3B. That is, the projection section 150 can perform projection over the entire imaging area E2. Conceivable examples of the subject 50 include a three-dimensional object, such as that shown in FIG. 3A, and a planar object, such as that shown in FIG. 3B. FIG. 3B shows a case where image data 70 representing a character entry box (character box with ruled lines) is projected on a subject 50 formed of a white sheet and the user performs drawing operation thereon. In the present embodiment, the drawing path L can thus be projected irrespective of the shape of the subject 50 when the light emitting pen 3 is moved and the position recognition section 122 recognizes the movement.

To avoid discrepancy between the position specified by the light emitting pen 3 and the position where the projection section 150 performs projection, calibration between the two positions is required in advance. For example, the calibration is conceivably made by using the imaging sensor 111 to capture an image of a predetermined pattern projected by the projection section 150.

The drawing path L projected by the projection section 150 remains projected until the user performs delete operation. The delete operation is conceivably performed by pressing a predetermined operation key provided on the operation panel 14. The delete operation may instead be performed as follows: The projection section 150 projects as the image data a GUI (graphical user interface) operation panel containing a plurality of operation keys; and the user uses the light emitting pen 3 to select a “delete” operation key. In this case, the GUI preferably contains operation keys corresponding to a variety of types of delete operation, such as “delete all” and “delete most recently drawn image.”

Further, the projection section 150 can perform projection in such a way that only the drawing path L is displayed in a visible manner and the other portion (background of drawing path L) is displayed in black to allow the user to think as if the user were actually performing drawing operation on the subject 50. Moreover, the portion other than the drawing path L can be displayed in white or any other bright color, which serves as an auxiliary light source that illuminates the subject 50.

The externally outputting section 170 outputs the output image G generated by the image processor 160 (output image generation section 162) to the projector 2 at a predetermined frame rate. When the overhead camera 1 has a recording/reproduction function, the externally outputting section 170 outputs a reproduced image (reproduced video images) to the projector 2.

The procedure according to which the overhead camera 1 operates will next be described with reference to the flowchart shown in FIG. 5. Having detected light emitted from the light emitting pen 3 (S01: Yes), the overhead camera 1 judges that the user has started drawing operation and reads a captured image captured before the drawing operation starts from the captured image storage portion 131 (S02). The overhead camera 1 further produces the drawing path L based on the path along which the light emitting pen 3 has been moved (S03) and combines the produced drawing path L with the read captured image to produce a combined image (S04). The overhead camera 1 then outputs the produced combined image to the projector 2 (S05). The overhead camera 1 subsequently judges whether the light emitting pen 3 has stopped emitting light. When the light emitting pen 3 has not stopped emitting light (S06: No), the control returns to S03. On the other hand, when the light emitting pen 3 has stopped emitting light (S06: Yes), the overhead camera 1 switches the output image from the combined image to realtime captured images being captured by the imaging section 110 (S07), and the control returns to 501. When no light emitted from the light emitting pen 3 is detected in S01 (S01: No), the overhead camera 1 also outputs realtime captured images (S07) and keeps outputting them until light emitted from the light emitting pen 3 is detected.

As described above, according to the first embodiment of the invention, when the light emitting pen 3 operated toward the subject 50 is moved, the drawing path L, which visualizes the path along which the light emitting pen 3 has been moved, is projected on the subject 50, whereby the user can have a sensation as if the user performed writing operation directly on the subject 50.

Further, since it is judged whether or not the user is performing drawing operation with the light emitting pen 3 and a combined image that is a combination of the captured image 50m of the subject 50 and the drawing path L is outputted instead of realtime captured images when the user is performing drawing operation, the light emitting pen 3, the user's “hand,” and other types of information can be excluded from the output image G. Only information considered to be essentially required can thus be outputted to the projector 2. Further, since a captured image before the user starts drawing operation is read from the captured image storage portion 131 as the captured image 50m of the subject 50, a combined image can be readily produced.

In the embodiment described above, the drawing path L is produced based on the path along which the light emitting pen 3 has been moved, and the drawing path L is projected toward the subject 50, but the light emitting pen 3 is not necessarily moved. For example, the user may orient the light emitting pen 3 toward the subject 50 and specify an arbitrary position on the subject 50 to project a predetermined image in the specified position. Conceivable examples of the “predetermined image” include an arrow or any other pointer, an enclosing box, a character, a symbol, a numerical number, a star-shaped mark used in celestial body learning, and a variety of other figures and patterns.

Further, the user may be allowed to select what kind of image is used as the “predetermined image.” In this case, the projection section 150 may project a GUI, and the “predetermined image” may be determined in accordance with an operation key selected with the light emitting pen 3. Further, the color of an object drawn with the light emitting pen 3 and the thickness of a drawn line may be selected on the GUI.

Moreover, instead of projecting the “predetermined image,” the overhead camera 1 may provide predetermined decoration on the subject 50 in a position specified with the light emitting pen 3. For example, when the subject 50 is a three-dimensional object, conceivable examples of the predetermined decoration include coloring only one surface including the specified position, displaying nothing on a portion around the specified position (displaying one of the surfaces as if it were transparent, for example, at the time of powering the overhead camera on by using an image of the subject mounting surface having been captured and stored in advance), and otherwise processing a portion around the specified position.

Further, a plurality of types of operation member (light emitting pen 3) may be used, and the “predetermined image” or the decoration method may be determined in accordance with the type of the operation member. That is, the plurality of types of operation member are conceivably used as follows: When a first pen is used to specify a position, a pointer is projected in the position; when a second pen is used to specify a position, an enclosing box is projected in the position; and when a third pen is used to specify a position, the surface including the specified position is colored.

Further, in the embodiment described above, whether or not the user is performing drawing operation is judged based on whether or not the light emitting pen 3 is emitting light, but the judgment may be made by using any other method. For example, the light emitting pen 3 is provided with a button (not shown) to be pressed when the user starts drawing operation, and a signal representing that the button has been pressed is transmitted to the main body of the overhead camera 1, for example, by using infrared or wireless communication. The overhead camera 1 (drawing judgment section 121) receives the signal representing the pressing action and judges whether or not the user is performing drawing operation. The configuration described above allows accurate judgment of whether or not the user is performing drawing operation.

Further, in the embodiment described above, the light emitting member in the light emitting pen 3 is an LED by way of example. A pulse signal may be applied to the LED, or the state of the LED may periodically change. For example, the LED does not necessarily emit monochrome light and may, for example, emit light the color of which sequentially changes among red, blue, green, and other colors. Further, the LED does not necessarily emit light in a fixed manner, and the light emission width, light emission amplitude, and other factors of the emitted light may change. Even the wavelength, pulse, intensity, modulation, quality, and other factors of the emitted light may change. Moreover, the overhead camera 1 may be configured to detect a plurality of types of light (such as light from LED, infrared light, and light from laser light source). When a laser light source is used as the light emitting member, the phrase “a position specified with an operation member” in the appended claims refers to the position on the subject 50 where the laser light is irradiated.

Further, the phrase “judges whether or not drawing operation is being performed by using the operation member based on the state of the operation member” in the appended claims includes judging whether or not drawing operation is being performed based on the change in the color of the light from or the state of light emission of the operation member (light emitting pen 3) described above.

Further, the position specified by the operation member is not necessarily detected based on the image analysis using a captured image but may be detected, for example, by using radio waves, ultrasonic waves, an azimuth sensor, or a pressure sensor (for example, when the subject 50 is a planar object, it is conceivable to incorporate any of the sensors described above in the surface on which the subject 50 is placed). Moreover, two or more of the detection methods described above may be combined with each other and used to detect the specified position.

In the embodiment described above, a combined image is produced by assuming that “a captured image containing only the subject 50”=“a captured image read from the captured image storage portion 131,” but “a captured image containing only the subject 50” may be produced by using any other method. For example, “a captured image containing only the subject 50” may be produced by assuming that the subject 50 is a stationary object and subtracting motion image information, such as the light emitting pen 3, the user's “hand,” and the drawing path L, from realtime captured images from the imaging section 110.

Further, in the embodiment described above, a captured image is regularly stored in the captured image storage portion 131, but a captured image may be stored in response to user's predetermined operation. The predetermined operation may be performed by using the operation panel 14 or a GUI projected by the projection section 150.

When the overhead camera 1 has a recording/reproduction function, a combined image may be recorded rather than realtime captured images during a period in which it is judged that user is performing drawing operation. Further, the user may choose which image is recorded, a combined image or realtime captured images.

Further, in the embodiment described above, the drawing path L projected by the projection section 150 remains projected until the user performs delete operation, but the drawing path L having been projected may be deleted whenever the light emitting pen 3 stops emitting light. According to this configuration, the user's delete operation can be omitted.

Further, in the embodiment described above, the single imaging sensor 111 captures an image of the subject 50 and recognizes the position of the light emitting pen 3, but a dedicated sensor may be provided for each of the actions. In this case, however, calibration for positioning the sensors relative to each other is required. The calibration is, for example, made as follows: A sensor for imaging is used to capture an image of a predetermined pattern projected by the projection section 150; a sensor for recognizing the position of the light emitting pen 3 is used to recognize the position of the light emitting pen 3; and the captured image and the recognized position are compared with each other.

### Second Embodiment

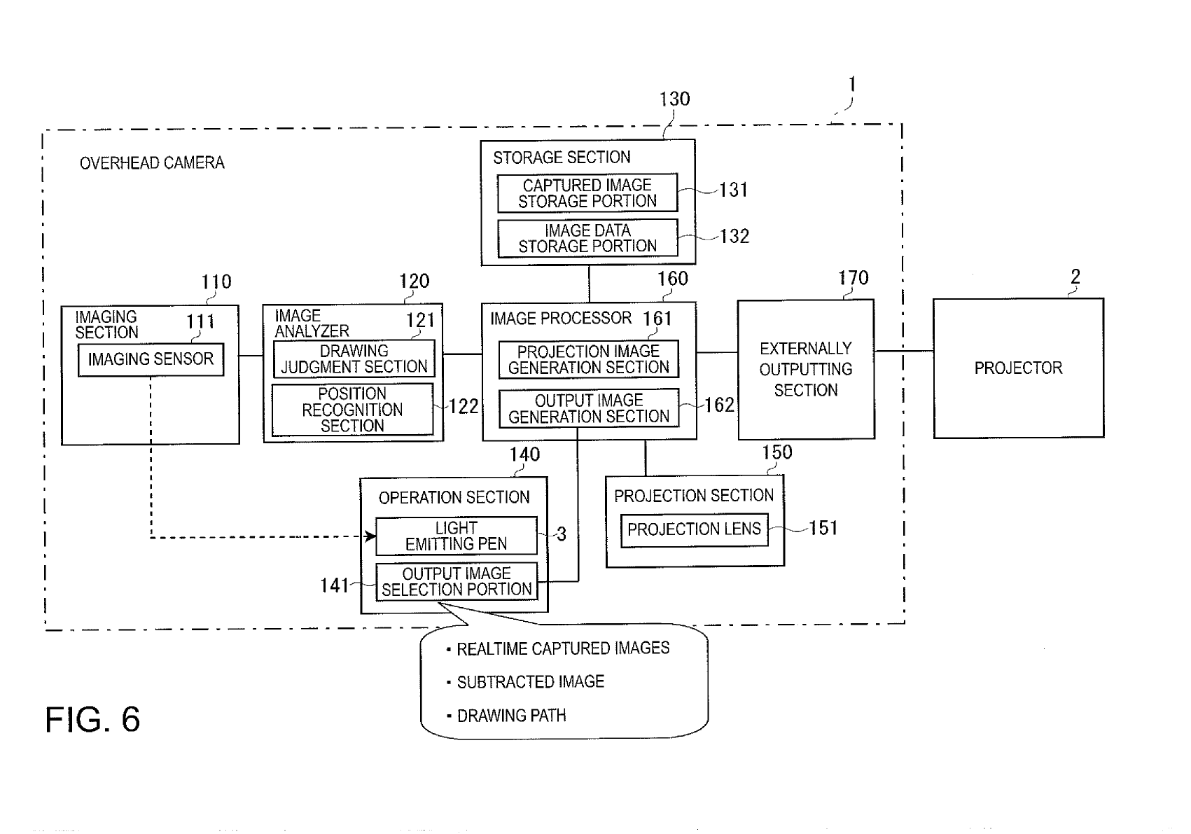

A second embodiment of the invention will be described with reference to FIGS. 6 to 8. In the first embodiment described above, when the user is performing drawing operation, a combined image that is a combination of the captured image 50m of the subject 50 and the drawing path L is produced as the output image G. In the present embodiment, the user selects the output image G to be outputted when the user is performing drawing operation. The following description will be made only of points different from those in the first embodiment. In the present embodiment, the same components as those in the first embodiment have the same reference characters, and no detailed description thereof will be made. Further, the variations applied to the components in the first embodiment are also applied to the same components in the present embodiment in the same manner.

FIG. 6 is a block diagram of an overhead camera 1 according to the second embodiment. The overhead camera 1 according to the present embodiment differs from the overhead camera 1 according to the first embodiment (see FIG. 2) in that an output image selection portion 141 is added in the operation section 140. The output image selection portion 141 allows the user to select whether “realtime captured images” being captured by the imaging section 110, the “subtracted image,” or the “drawing path” is outputted when the user is performing drawing operation. The output image selection portion 141 may be formed of the operation panel 14 (see FIG. 1) or a GUI projected by the projection section 150. An image selected by using the output image selection portion 141 is produced by the image processor 160 in the present embodiment during a period in which the user is performing drawing operation.

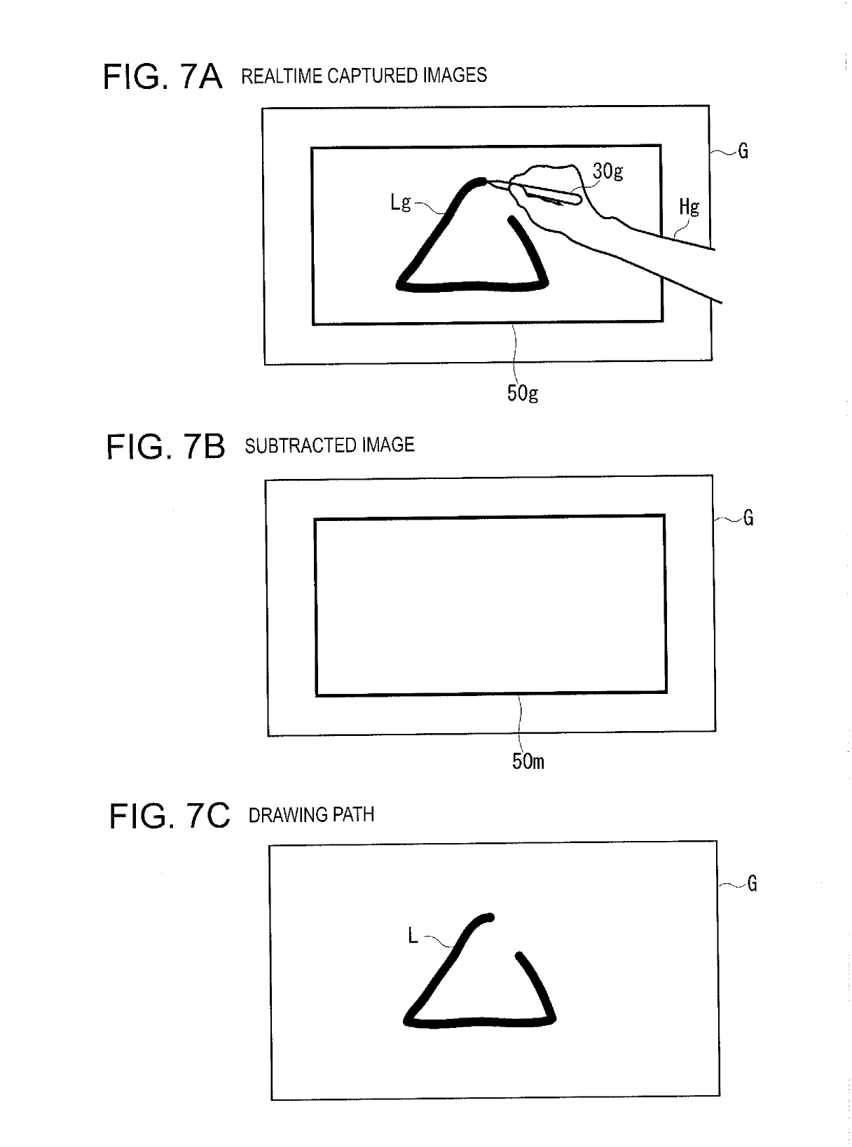

FIGS. 7A to 7C show variations of the output image G. For example, FIG. 7A shows an example of the output image G in a case where the user selects “realtime captured images”. When the user selects “realtime captured images,” realtime images being captured by the imaging section 110 (motion images containing image 50g of subject 50, image Lg of drawing path L, image 3g of light emitting pen 3, and image Hg of user's “hand”) are outputted, as shown in FIG. 7A.

When the user selects the “subtracted image,” an output image G that does not contain the image Lg of the drawing path L is outputted, as shown in FIG. 7B. In this case, the captured image 50m read from the captured image storage portion 131 when the user starts drawing operation, that is, a captured image before the drawing operation starts is used as the “subtracted image.” When the user selects the “drawing path,” the drawing path L produced based on the path of the movement of the light emitting pen 3 recognized by the position recognition section 122 is outputted as the output image G, as shown in FIG. 7C.

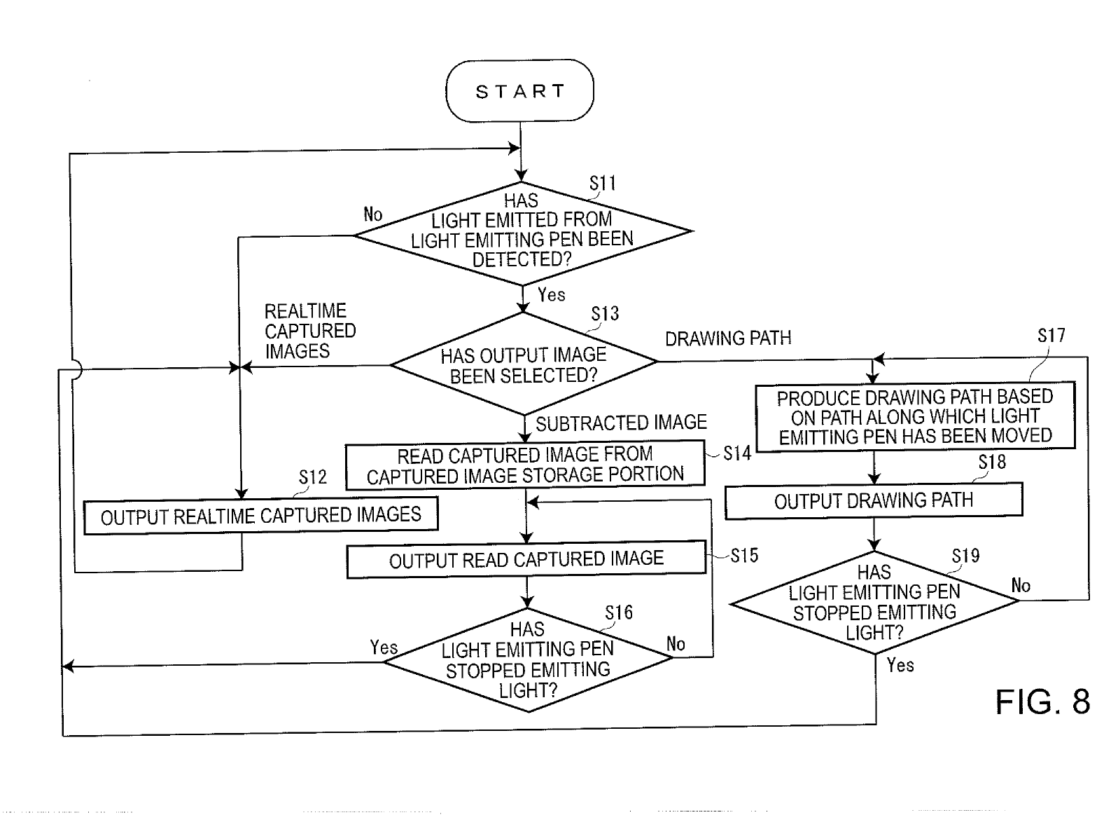

The procedure according to which the overhead camera 1 according to the present embodiment operates will next be described with reference to the flowchart shown in FIG. 8. Having detected no light emitted from the light emitting pen 3 (S11: No), the overhead camera 1 judges that the user is not performing drawing operation and outputs realtime captured images being captured by the imaging section 110 to the projector 2 (S12). The control then returns to S11. Having detected light emitted from the light emitting pen 3 (S11: Yes), the overhead camera 1 judges that the user is performing drawing operation and detects a selected output image G (S13). When the user has selected “realtime captured images,” realtime captured images being captured by the imaging section 110 are outputted even during the drawing operation (S12).

When the user has selected the “subtracted image” as the output image G to be drawn, the captured image 50m captured before the drawing operation starts is read from the captured image storage portion 131 (S14), and the read captured image 50m is outputted (S15). It is subsequently judged whether the light emitting pen 3 has stopped emitting light. When the light emitting pen 3 has not stopped emitting light (S16: No), the control returns to S15. When the light emitting pen 3 has stopped emitting light (S16: Yes), the output image is switched to realtime captured images (S12). When the user has selected the “drawing path” as the output image G to be drawn, the drawing path L is produced based on the path along which the light emitting pen 3 has been moved (S17), and the produced drawing path L is outputted (S18). Whether or not the light emitting pen 3 has stopped emitting light is subsequently judged. When the light emitting pen 3 has not stopped emitting light (S19: No), the control returns to S17. On the other hand, when the light emitting pen 3 has stopped emitting light (S19: Yes), the output image is switched to realtime captured images (S12).

As described above, according to the second embodiment of the invention, since the user can select a desired output image G from “realtime captured images,” the “subtracted image,” and the “drawing path,” the operability can be improved. For example, the second embodiment can be used by selecting the “subtracted image” in an application in which the user desires to check the drawing path L on the subject 50 but does not desire to include the drawing path L in the output image G (application in which the user does not desire to display the drawing path L in the projection image for a projector 61). For example, in an educational scene, a teacher who attempts to show students how to use compasses can use the second embodiment, for example, as follows: While letting the students consider which portion of the compasses corresponds to the fulcrum, the teacher marks the fulcrum of the compasses, which are the subject 50; the teacher waits for a response from the students; and the teacher shows the mark (drawing path L) on the subject 50 or the projection image for a projector 61.

Further, when the user selects the “subtracted image” as the output image G, since the captured image 50m captured before drawing operation starts is read from the captured image storage portion 131, a “subtracted image” that does not contain the light emitting pen 3, the user's hand, the drawing path L, or any other types of information can be readily produced.

In the second embodiment described above, though the captured image 50m captured before drawing operation starts and read from the captured image storage portion 131 is used as the “subtracted image,” the “subtracted image” may be produced by using any other method. For example, the “subtracted image” may be produced by subtracting the drawing path L from realtime captured images being captured by the imaging section 110. In this case, the “subtracted image” may be produced as follows: The drawing path L produced based on images captured after drawing operation starts is separately stored; realtime captured images are captured at unit time intervals; and the drawing path L drawn after the drawing operation starts may be subtracted from the realtime captured images. According to the configuration described above, the imaging section 110 is not required to regularly capture images in order to produce the captured image 50m captured before the drawing operation starts. In the present configuration, the output image G does not contain the drawing path L but contains the image 3g of the light emitting pen 3 and the image Hg of the user's “hand.” To produce an output image G containing only the image 50g of the subject 50, it may be assumed that the subject 50 is a stationary object, and motion image information, such as the light emitting pen 3, the user's “hand,” and the drawing path L, may be subtracted from the realtime captured images from the imaging section 110. The “subtracted image” may thus be produced.

Further, in the second embodiment described above, any of “realtime captured images,” the “subtracted image,” or the “drawing path” is selectable as the output image G to be drawn, but only the “subtracted image” or the “drawing path” may be allowed to be outputted when the user is performing drawing operation. That is, the second embodiment may be so configured that when the user is performing drawing operation, the “subtracted image” or the “drawing path” is outputted as the output images G, whereas when the user is not performing drawing operation, the “realtime captured images” is outputted.

Further, when the overhead camera 1 has a recording/reproduction function, the output image G selected by using the output image selection portion 141 may be recorded in a period during which the user is performing drawing operation. Further, the image to be separately recorded may be selected from “realtime captured images,” the “subtracted image,” and the “drawing path” irrespective of the selection made by using the output image selection portion 141.

The two embodiments have been shown in the above description. Each of the components of the projection system SY shown in each of the embodiments can be provided in the form of a program. Further, the program can be provided in the form of a variety of recording media (such as CD-ROM and flash memory) on which the program is stored. That is, a program that causes a computer to function as each of the components of the projection system SY and a recording medium on which the program is recorded are encompassed within the scope of the invention.

In each of the embodiments described above, the projector 2 is presented as an image display apparatus byway of example, but a monitor, a PC (personal computer), a tablet terminal, or any other apparatus may be used as the image display apparatus. In addition, changes can be made as appropriate to the extent that the changes do not depart from the substance of the invention.

The entire disclosure of Japanese Patent Application No. 2012-264855, filed Dec. 4, 2012 is expressly incorporated by reference herein.

What is claimed is:

1. An overhead camera comprising:
an imaging section that captures an image of a subject;
a position recognition section that recognizes a position specified with an operation member operated toward the subject; and
a projection section that projects a predetermined image in the position specified with the operation member.

2. The overhead camera according to claim 1,
wherein when the position specified with the operation member is moved, the projection section projects a drawing path that visualizes the path along which the specified position has been moved.

3. The overhead camera according to claim 2, further comprising:
a drawing judgment section that judges whether or not drawing operation is performed by using the operation member, and
an output section that outputs an image to an image display apparatus,
wherein the output section
outputs realtime captured images being captured by the imaging section when no drawing operation is being performed by using the operation member, and
outputs a combined image that is a combination of a captured image of the subject and the drawing path when drawing operation is being performed by using the operation member.

4. The overhead camera according to claim 3,
wherein the drawing judgment section judges whether or not drawing operation is being performed by using the operation member based on the state of the operation member.

5. The overhead camera according to claim 4,
wherein the position recognition section recognizes the position of a light emitting member incorporated in the operation member as the position specified with the operation member, and
the drawing judgment section judges that the drawing operation is being performed when the position recognition section detects that the light emitting member is emitting light, whereas judging that the drawing operation is not being performed when the position recognition section detects that the light emitting member is not emitting light.

6. The overhead camera according to claim 3, further comprising a storage section that stores a most recently captured image and a few of the following captured images produced by the imaging section that regularly captures images,
wherein the output section reads a predetermined captured image from the storage section when drawing operation is initiated by using the operation member and outputs a combined image that is a combination of the predetermined captured image and the drawing path in a period during which the drawing operation is being performed by using the operation member.

7. The overhead camera according to claim 2, further comprising:
a drawing judgment section that judges whether or not drawing operation is being performed by using the operation member, and
an output section that outputs an image to an image display apparatus,
wherein the output section does not output realtime captured images being captured by the imaging section but outputs a subtracted image that does not contain the drawing path in a period during which the drawing operation is being performed by using the operation member.

8. The overhead camera according to claim 7, further comprising a storage section that stores a most recently captured image and a few of the following captured images produced by the imaging section that regularly captures images,
wherein the subtracted image is a predetermined captured image read from the storage section when drawing operation is initiated by using the operation member.

9. The overhead camera according to claim 7,
wherein the subtracted image is an image produced by subtracting the drawing path from realtime captured images being captured by the imaging section.

10. The overhead camera according to claim 7, further comprising a selection portion that allows selection of one of the realtime captured images being captured by the imaging section, the subtracted image, and the drawing path as an output from the output section,
wherein the output section outputs an image selected by using the selection portion in a period during which drawing operation is being performed by using the operation member.

11. The overhead camera according to claim 1,
wherein the projection section can project image data stored in advance or externally inputted image data toward the subject.

12. The overhead camera according to claim 1,
wherein the position recognition section recognizes the position specified with the operation member based on a result of imaging operation performed by the imaging section.

13. A method for controlling an overhead camera, the method comprising:
capturing an image of a subject;
recognizing a position specified with an operation member operated toward the subject; and
projecting a predetermined image in the position specified with the operation member.
